(19) United States
(12) Patent Application Publication
(10) Pub. No.: US 2012/0161407 A1
(43) Pub. Date: Jun. 28, 2012

(54) Transportation Cart

(76) Inventor: Calvin Charles Thicke, Port Dover (CA)

(21) Appl. No.: 12/978,038

(22) Filed: Dec. 23, 2010

(51) Int. Cl. B62B 3/00

(52) U.S. Cl. 280/47.35

(57) ABSTRACT

A transportation cart includes a base frame carried on ground wheels one or more of which is steerable to guide movement of the cart. The base frame includes a rear platform and a pair of spaced parallel side arms extending forwardly so as define an open area between the arms with an open front between the arms at the front of the arms. Each of the arms has a ground wheels which is carried on a mounting allowing the axle and wheel to rotate about an upright axis at the arm. A mast supports a guide pulley of a winch above the open area between the arms for lifting the load from the ground with removable cross bars being insertable into sleeves on the arms to carry the load when lowered onto the bars.

This invention relates to a transportation cart for lifting and carrying various objects for example for use in landscaping and similar projects where articles such as rocks, trees and debris are required to be transported often through narrow areas.

### BACKGROUND OF THE INVENTION

Many different designs of transportation cart have previously been proposed. For example the following US patents disclose arrangements from lifting objects:

U.S. Pat. No. 2,382,054 (Hercik) issued Aug. 14, 1945 discloses a portable crane including a mast carried on a base with a pair of forwardly extending arms each carrying a caster wheel at the front end. The base includes a steering dolly at the rear allowing the crane to be moved to different locations.

U.S. Pat. No. 3,494,492 (Thiermann) issued Feb. 10, 1970 discloses a cart or dolly defined by a top rail from which a heavy load can be suspended. The rail is carried on a pair of posts with a wheeled support at the bottom of each post movable in steering action by a manually operable handle.

U.S. Pat. No. 4,421,209 (Vermette) issued Dec. 20, 1983 discloses a cart with a mast and winch which mast is carried on a base defined by a pair of forwardly extending arms with a steering system at the rear and a caster wheel at a forward end of each arm

U.S. Pat. No. 5,064,079 (Bowerman) issued Nov. 12, 1991 discloses a similar arrangement to that of Thiermann with a cart or dolly defined by a top rail from which a heavy load can be suspended. The rail is carried on a pair of posts with a caster wheels at the base.

U.S. Pat. No. 5,975,826 (Scholder) issued Nov. 2, 1999 discloses a hand truck with attachments with a base mounted on caster wheels carrying a mast and winch. The base includes two spaced arms which can pivot to the sides.

### SUMMARY OF THE INVENTION

It is one object of the invention to provide a transportation cart.

According to one aspect of the invention there is provided a transportation cart comprising:

a base frame;

ground wheels for supporting the frame for movement over the ground;

one or more of the wheels being steerable to guide movement of the cart;

the base frame including a pair of spaced parallel side arms extending forwardly so as define an open area between the arms with an open front between the arms at the front of the arms;

the base frame and the arms being arranged to allow the cart to be moved forwardly so as to move the arms into a position on respective sides of a load with the load passing though the open front into the open area between the arms;

each of the arms having a respective one of the ground wheels thereon for supporting the arm;

a mast carried on the base frame;

a winch having a cable passing over a guide pulley on the mast above the open area between the arms for lifting the load in the open area;

and one or more removable support members which can be inserted into place bridging the arms so as to provide a support for the load when lifted from the ground and lowered onto the support members, the support member or members being removable to allow the load to enter the open area.

Preferably the ground wheel of each of the arms is mounted on an axle which is carried on a mounting allowing the axle and wheel to rotate about an upright axis at the arm so as to move the wheel on its axle about the axis from an inner position of the wheel inwardly of the arm thereby reducing a width between the wheels to an outer position of the wheel outwardly of the arm removing the wheels from the open area to allow entry of the load.

Preferably the mounting is arranged to hold the wheels in the inner position and the outer position with the axle fixed against pivotal movement around the axis. Thus the wheels are not caster wheels but are fixed for forward movement in both the two positions.

Preferably the mounting is on the end of the arm allowing the wheel to rotate around the upright axis at the end of the arm.

Preferably the removable support member or members each comprise an elongate member or bar having its ends carried on the arms for example in a sleeve attached to the arms, into which the bar can be inserted.

Preferably the cart includes one or more rear wheels, preferably two for stability, attached to a manually operable guide arm for causing steering movement of the rear wheels. In a manually operated version of the cart, pushing or pulling forces are applied through the guide arm to move the cart. In a motor driven version, the guide arm acts only to steer.

Preferably the pair of rear wheels mounted for common steering movement about an upright axis between the rear wheels. However other steering mechanism can be used.

Preferably the cart includes a rear platform between the rear wheels to which the mast is attached.

In a motor driven version, there is provided a motor for driving one or more of the rear ground wheels and the motor is mounted on the platform at the rear wheels for driving one or both of the rear wheels.

Preferably there is also provided motor for driving the winch.

Preferably there is provided an engine for driving the motors hydraulically. However the system may be drive electrically for example from a battery.

Preferably the arms are extendible by adjustment relative to a rear part of the frame to increase the width of the open area between the arms for a longer load by 6″ (3″ per side) by pulling a total of six pins and sliding the sides outwardly and re-pinning. This is important to the design and uses. To make this adjustment motion easy, the two front wheels can be turned ¼-turn (90 degrees from their locked position) to place them in alignment with the direction of required movement, to slide the sides in or out. The wheels are not pinned into place during this adjustment action. Aligning the wheels in this way works well to facilitate the sliding action, especially when on uneven or soft ground.

Preferably, in addition to or as an alternative to the load carrying cross bars, each of the arms includes a swivel mounting for receiving and supporting a pivot coupling of a bucket to be carried between the arms, the bucket being pivotal about a horizontal transverse axis to allow dumping of the bucket when pulled by the cable.

Preferably one or more of the removable support members can be inserted into place bridging the arms so as to provide a support for the bucket.

Preferably the bucket is rectangular with two side parallel to the arms.

The arrangement describe din detail hereinafter is arranged in use to place up to 1 ton rocks, tree balls and landscape supplies in backyards, allowing passage through an opening as small as a three feet wide gate.

It can also serve the auto wrecking industry to remove engines and transmissions from between cars, nurserymen/landscapers to remove tree balls and rental stores for homeowner use.

It can also remove small stumps and trees as well as tear out old fence post footings, transport rectangular stone steps, lockstone, etc. The arrangement can include a simple “soil bucket” as a option so that landscapers can fill and move 4 to 6 wheelbarrow loads of soil, gravel, sand, etc in and out of an area at a time, without the conventional slow and difficult wheel barrowing process. The bucket can be a simple metal box with a hopper door that the hoist will lift and tilt to empty.

According to a second aspect of the invention there is provided a transportation cart comprising:

a base frame;

ground wheels for supporting the frame for movement over the ground;

one or more of the wheels being steerable to guide movement of the cart;

the base frame including a pair of spaced parallel side arms extending forwardly so as define an open area between the arms with an open front between the arms at the front of the arms;

the base frame and the arms being arranged to allow the cart to be moved forwardly so as to move the arms into a position on respective sides of a load with the load passing though the open front into the open area between the arms;

each of the arms having a respective one of the ground wheels thereon for supporting the arm;

a mast carried on the base frame;

a winch having a cable passing over a guide pulley on the mast above the open area between the arms for lifting the load in the open area;

wherein the ground wheel of each of the arms is mounted on an axle which is carried on a mounting allowing the axle and wheel to rotate about an upright axis at the arm so as to move the wheel on its axle about the axis from an inner position of the wheel inwardly of the arm thereby reducing a width between the wheels to an outer position of the wheel outwardly of the arm removing the wheels from the open area to allow entry of the load.

According to a third aspect of the invention there is provided a transportation cart comprising:

a base frame;

ground wheels for supporting the frame for movement over the ground;

one or more of the wheels being steerable to guide movement of the cart;

the base frame including a pair of spaced parallel side arms extending forwardly so as define an open area between the arms with an open front between the arms at the front of the arms;

the base frame and the arms being arranged to allow the cart to be moved forwardly so as to move the arms into a position on respective sides of a load with the load passing though the open front into the open area between the arms;

each of the arms having a respective one of the ground wheels thereon for supporting the arm;

a mast carried on the base frame;

a winch having a cable passing over a guide pulley on the mast above the open area between the arms for lifting the load in the open area;

each of the arms includes a swivel mounting for receiving and supporting a pivot coupling of a bucket to be carried between the arms, the bucket being pivotal about a horizontal transverse axis to allow dumping of the bucket when pulled by the cable.

### BRIEF DESCRIPTION OF THE DRAWINGS

One embodiment of the invention will now be described in conjunction with the accompanying drawings in which:

FIG. 1 is a side elevational view of a cart according to the present invention showing the basic cart for use in lifting and carrying a load.

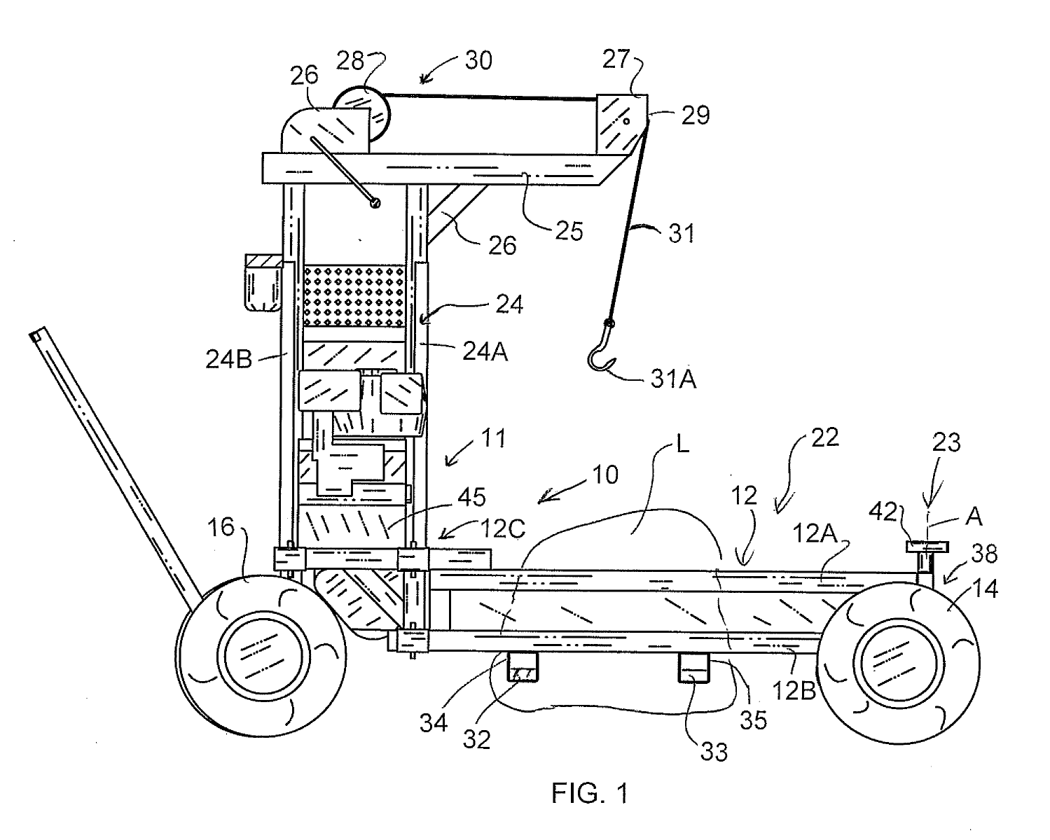

FIG. 2 is an isometric view of the cart of FIG. 1 including the addition of an optional bucket carried on the cart.

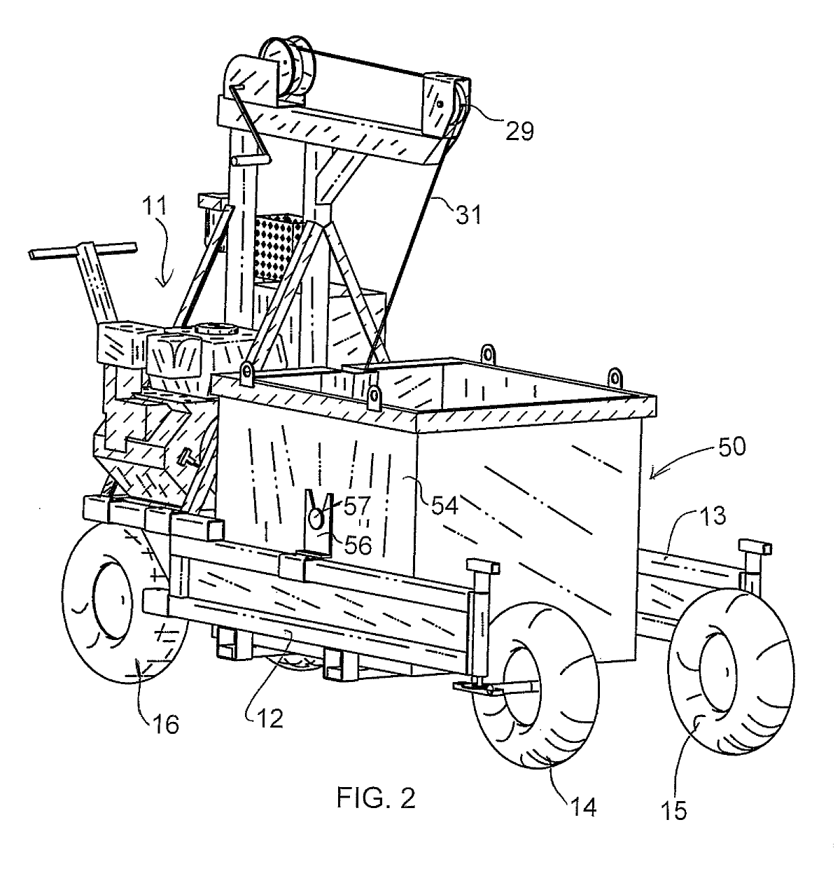

FIG. 3 is a side elevational view of the cart of FIG. 2 showing the bucket in the transport position.

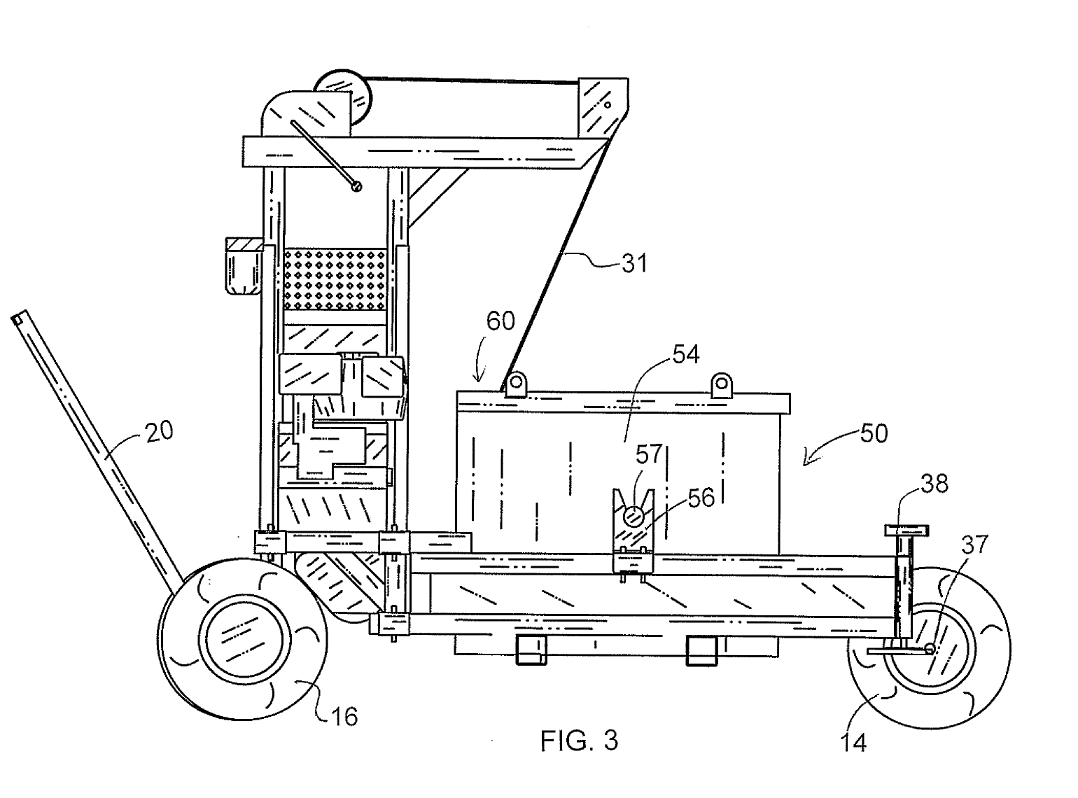

FIG. 4 is a side elevational view of the cart of FIG. 2 showing the bucket in the dump position.

FIG. 5 is a top plan view of the cart of FIG. 2 showing the wheels in the transport position.

FIG. 6 is a top plan view of the cart of FIG. 2 showing the wheels in the loading position.

In the drawings like characters of reference indicate corresponding parts in the different figures.

### DETAILED DESCRIPTION

The transportation cart shown in the Figures comprises a base frame 10 defined by a rear platform section 11 and a pair of forwardly extending arms 12 and 13.

Each of the arms 12, 13 includes a respective ground wheel 14, 15 and the platform section 11 includes a pair of rear ground wheels 16 and 17 for supporting the frame for movement over the ground. The rear wheels are carried on a transverse support 18 which defines and carries a common axle 19 for the wheels so that they are coupled together for common movement on the support 18 which is steerable by a manually operable guide arm 20 with a cross-bar 21 to guide movement of the cart.

The base frame includes the pair of spaced parallel side arms 12, 13 extending forwardly from the platform section 12 at the rear so as define an open area 22 between the arms with an open front 23 between the arms at the front of the arms. In this way, the base frame and the arms are arranged to allow the cart to be moved forwardly so as to move the arms into a position on respective sides of a load L with the load L passing though the open front 23 into the open area 22 between the arms 12 and 13.

A mast 24 is carried on the rear platform section 11 of the base frame 10 and stands upwardly. The mast 24 includes front and rear posts 24A and 24B carrying a top rail 25 which extends forwardly across a top of the posts and is braced by a cross-brace 26. On top of the rail is mounted support brackets 26 and 27 for rear pulley 28 and front pulley 29 of a winch system 30 having a cable 31 passing over and depending from the front guide pulley 29 on the mast 24 above the open area 22 between the arms 12, 13 for lifting the load L in the open area.

Two removable support members 32, 33 are provided which can be inserted into place bridging the arms 12, 13 so as to provide a support for the load L when lifted from the ground and lowered onto the support members. The support member or members 32 and 33 in the form of elongate bars are removable each from a pair of supporting sleeves 34, 35 on the arms to allow the load to enter the open area 22 through the front opening 23 as the cart is moved forwardly.

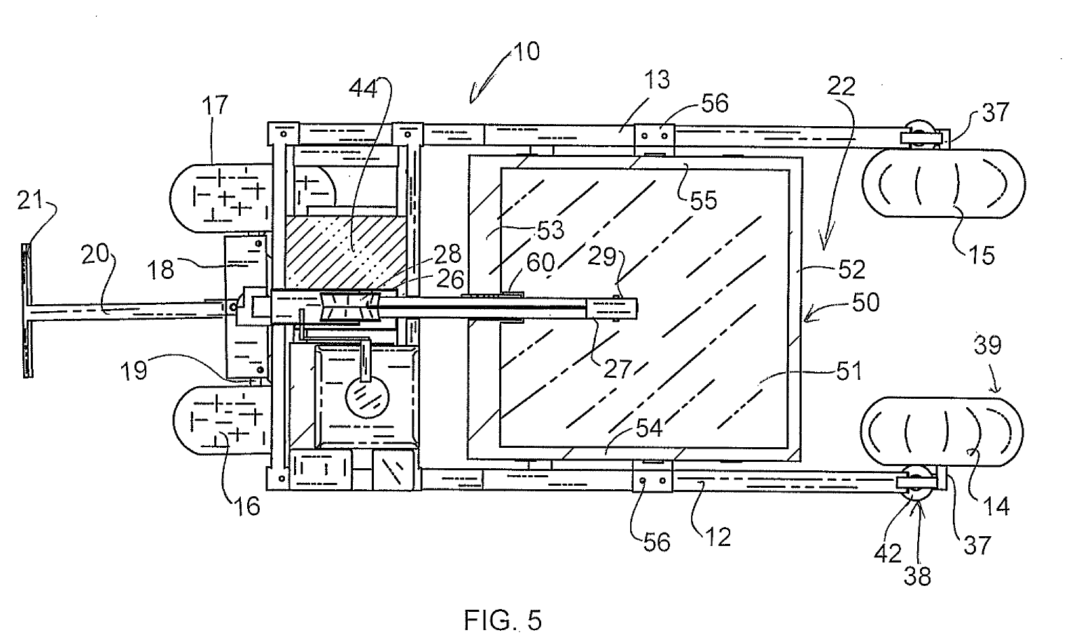

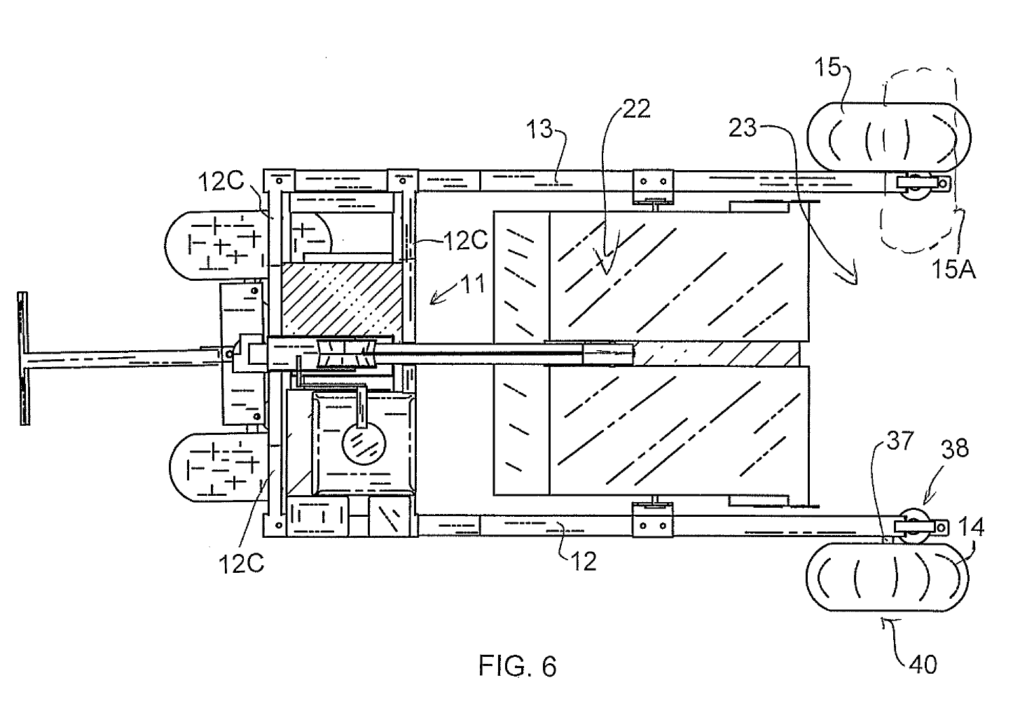

The ground wheel 14, 15 of each of the arms 12, 13 is mounted on an axle 37 which is carried on a mounting 38 allowing the axle 37 and wheel 14, 15 to rotate about an upright axis A at the arm so as to move the wheel on its axle about the axis A from an inner position 39 of the wheel inwardly of the arm as shown in FIG. 5 to an outer position 40 of the wheel outwardly of the arm as shown in FIG. 6. The outer position of FIG. 6 acts to remove the wheels from the open area 22 and the front opening 23 to allow entry of the load. The inner position of FIG. 5 acts to move the wheels into the open area 22 and the front opening 23 thereby reducing a width between the wheels and making the cart narrower to negotiate narrow paths often found in landscaping sites.

The mounting 38 includes a lock pin 42 which is arranged to hold the wheels fixed in the inner position and the outer position with the axle fixed against pivotal movement around the axis in these positions. Thus the wheels are not caster wheels but are fixed for forward movement in both the two positions and are movable between those two positions manually. The mounting 38 and the wheels carried thereby is on the end of the arm 12, 13 allowing the wheel to rotate around the upright axis A at the end of the arm to take up the inner and outer positions.

The cart includes one or more rear wheels 16, 17, preferably two for stability, attached to the manually operable guide arm 17 for causing steering movement of the rear wheels. In a manually operated version of the cart, pushing or pulling forces are applied through the guide arm to move the cart. In a motor driven version, the guide arm acts only to steer.

In the motor driven version shown in the Figures, there is provided a motor 44 for driving one or more of the rear ground wheels and the motor is mounted on the platform section 11 at the rear wheels 16, 17 for driving one or both of the rear wheels. In the arrangement shown the winch 30 is hand driven by a crank 30A at the rear mounting 26. However in the motor driven version preferably there is also provided motor for driving the winch.

An engine 45 is provided for driving the motors which can use a hydraulically driven system including a commercially available pump and drive motors. A suitable operator control system can be provided such as a two-direction pull bar at the handle. However the system may be driven electrically for example from a battery or mechanically using shafts and gears.

The arms 12 and 13 are formed from a pair of parallel rails 12A and 12B extendible in an adjustment mounting 12C relative to the rear platform part 11 of the frame to increase the width of the open area between the arms for a longer load by 6″ (3″ per side) by pulling total 6 pins (not shown) and sliding the sides 12, 13 outwardly to an outer position and re-pinning. To make this adjustment motion easy, the two front wheels 14, 15 can be turned ¼-turn (90 degrees) from their inner and outer locked positions to place them in alignment with the direction of required movement as shown at 15A in FIG. 6, to slide the sides 12, 13 in or out. It is not necessary for the wheels to be not pinned into place during this adjustment action. Aligning the wheels in this way works well to facilitate the sliding action, especially when on uneven or soft ground & is kind of novel.

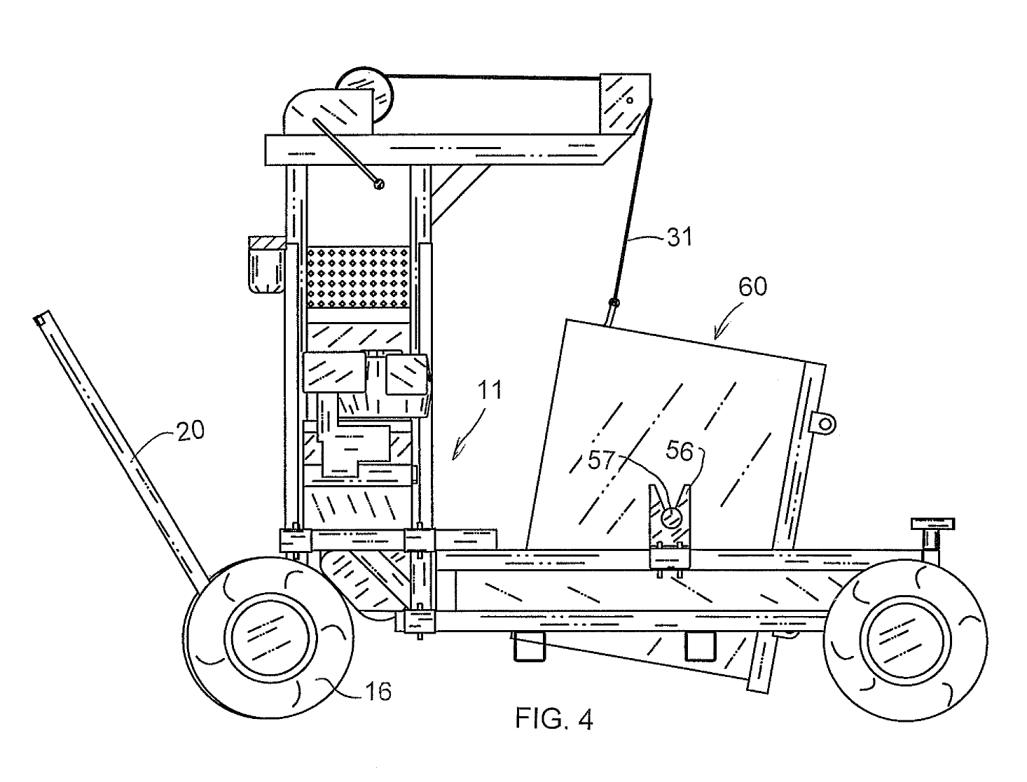

For use in carrying loads which are not liftable as an individual item such as sand, gravel etc, an optional bucket 50 is provided which is generally rectangular with a base 51, upstanding front and rear walls 52 and 53 and upstanding parallel side walls 54, 55. The cable 31 and its hook 31A extend to the bottom of the bucket through a tunnel 60 at the rear wall 53 so that the hook 31A attaches adjacent the bottom allowing the lifting force to overturn the bucket for dumping as shown in FIG. 4.

Each of the arms 12, 13 includes a swivel mounting 56 for receiving and supporting a pivot coupling 57 of a bucket to be carried between the arms, the bucket being pivotal about a horizontal transverse axis to allow dumping of the bucket when pulled by the cable. During transportation of the bucket, one of the removable support members is inserted into place bridging the arms so as to provide stability for the bucket. The bucket is dumped, with the support member removed, by operating the winch to pull the rear side of the bucket upwardly so that it rotates on the supports until inverted.

The pivot mounts or saddles 56 that hold the dump bucket can be removed by simply lifting them off. When removing the bucket from the cart, the lift bucket is moved clear by the winch and cable 31. That is the user pulls the pins mounting the saddles 56 and removes or slides the saddles forward away from the support pins 57 of the bucket, removes the front load bar from under the bucket and lowers bucket to the ground, so that the cart can be unhooked and driven away. When using dump bucket, the chains are removed, the winch cable is unwound and cable hooked onto the pin at front bottom of the bucket and wound up to lift the bucket. The bucket will be able to completely tip over to dump without the operator loosing control. The cart is then driven away from the dumped load or back and forth to grade out.

The device operates, with the bucket removed, to pick up and deliver a large rock, tree ball, etc as follows:

1. Put a chain around the rock or attach to a tree basket.

2. Rotate wheels ½ of rotation to allow cart width adjustment (if required).

3. Remove 3 pins per side to increase or decrease cart width and replace pins (if required).

4. Rotate the two rear wheels to the outer position and lock in place, thus opening the cart end to received the load.

5. Remove the two wood-covered load bars which slide out.

6. Place the cart around the load by moving forward to the required position.

7. Rotate the rear wheels back to inner side of cart and lock to reduce cart width for tight access (if required).

8. Place the winch onto the rock chain and lift load about 8″ up above ground.

9. Slide the load bars into place.

10. Lower the load onto bars and leave the winch attached to load under low stress to stabilize the load.

11. Move to the desired location.

12. Reverse the process to unload.

The cart has several uses and features as follows:

a) Locate rocks, trees in and out of confined spaces, yard.

b) Hydraulic system when used allows a casual walk speed.

c) The cart allows a 30″ wide as well as a 36″ wide net interior width for loads.

d) The winch has a brake, meaning it cannot freefall, when the handle is released, the load stays suspended and does not move.

e) When loading and unloading, a 6.5 hp engine is designed to be off so that the shut down hydraulic system acts as a good brake system.

f) The load can be moved in a narrow and convenient way. The smallest skidsteer that will lift the same load is 5′ wide minimum and about 4 tons.

g) When bucket is in tilted up dump position, the cart can be used to do some minor grading/levelling.

h) Bucket holds exactly ½ cubic yard.

j) The front driven wheels allow 45 degree turning angle.

k) The sidebars or arms 12 and 13 are quick-remove using 6 pins (3 pins each) to allow convenient storage and shipping.

l) The cart uses a total of 18 pins: 3 for securing sidebars, 3 for adjusting cart width, 2 to secure dump bucket saddles and 1 to hold the rear wheel in line: ×2 sides.

m) A chain basket can be provided (not shown) to define tree/rock chains, removed pins, hardware, etc.

n) It is possible even if forgotten before lifting the load to rotate the wheels under the load.

p) The maximum load can be as much as 1600 lbs (725 kg).

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A transportation cart comprising:
a base frame;
ground wheels for supporting the frame for movement over the ground;
one or more of the wheels being steerable to guide movement of the cart;
the base frame including a pair of spaced parallel side arms extending forwardly so as define an open area between the arms with an open front between the arms at the front of the arms;
the base frame and the arms being arranged to allow the cart to be moved forwardly so as to move the arms into a position on respective sides of a load with the load passing though the open front into the open area between the arms;
each of the arms having a respective one of the ground wheels thereon for supporting the arm;
a mast carried on the base frame;
a winch having a cable passing over a guide pulley on the mast above the open area between the arms for lifting the load in the open area;
and one or more removable support members which can be inserted into place bridging the arms so as to provide a support for the load when lifted from the ground and lowered onto the support members, the support member or members being removable to allow the load to enter the open area.

2. The cart according to claim 1 wherein the ground wheel of each of the arms is mounted on an axle which is carried on a mounting allowing the axle and wheel to rotate about an upright axis at the arm so as to move the wheel on its axle about the axis from an inner position of the wheel inwardly of the arm thereby reducing a width between the wheels to an outer position of the wheel outwardly of the arm removing the wheels from the open area to allow entry of the load.

3. The cart according to claim 2 wherein the mounting is arranged to hold the wheels in the inner position and the outer position with the axle fixed against pivotal movement around the axis.

4. The cart according to claim 3 wherein the mounting is on the end of the arm.

5. The cart according to claim 1 wherein the removable support member or members each comprise an elongate member having its ends carried on the arms.

6. The cart according to claim 5 wherein the ends are carried on the arms in a sleeve attached to the arms into which the member can be inserted.

7. The cart according to claim 1 wherein the cart includes one or more rear wheels attached to a manually operable guide arm for causing steering movement of the rear wheel or wheels.

8. The cart according to claim 1 wherein there is a pair of rear wheels mounted for common steering movement about an upright axis between the rear wheels.

9. The cart according to claim 1 wherein the cart includes a rear platform between the wheels to which the mast is attached.

10. The cart according to claim 1 wherein there is provided a motor for driving one or more of the ground wheels.

11. The cart according to claim 9 wherein there is provided a motor for driving one or more of the ground wheels and where in the motor is mounted on the platform at the rear wheels for driving one or both of the rear wheels.

12. The cart according to claim 11 wherein there is provided motor for driving the winch.

13. The cart according to claim 12 wherein there is provided an engine for driving the motors hydraulically, mechanically or electrically.

14. The cart according to claim 1 wherein arms are mounted for adjustment movement so that the spacing between the arms can be increased.

15. The cart according to claim 1 wherein each of the arms includes a swivel mounting for receiving and supporting a pivot coupling of a bucket to be carried between the arms, the bucket being pivotal about a horizontal transverse axis to allow dumping of the bucket when pulled by the cable.

16. The cart according to claim 15 wherein one or more of the removable support members can be inserted into place bridging the arms so as to provide a support for the bucket.

17. The cart according to claim 15 wherein the bucket is rectangular with two side parallel to the arms.

18. A transportation cart comprising:
a base frame;
ground wheels for supporting the frame for movement over the ground;
one or more of the wheels being steerable to guide movement of the cart;
the base frame including a pair of spaced parallel side arms extending forwardly so as define an open area between the arms with an open front between the arms at the front of the arms;
the base frame and the arms being arranged to allow the cart to be moved forwardly so as to move the arms into a position on respective sides of a load with the load passing though the open front into the open area between the arms;
each of the arms having a respective one of the ground wheels thereon for supporting the arm;
a mast carried on the base frame;
a winch having a cable passing over a guide pulley on the mast above the open area between the arms for lifting the load in the open area;
wherein the ground wheel of each of the arms is mounted on an axle which is carried on a mounting allowing the axle and wheel to rotate about an upright axis at the arm so as to move the wheel on its axle about the axis from an inner position of the wheel inwardly of the arm thereby reducing a width between the wheels to an outer position of the wheel outwardly of the arm removing the wheels from the open area to allow entry of the load.

19. A transportation cart comprising:
a base frame;
ground wheels for supporting the frame for movement over the ground;
one or more of the wheels being steerable to guide movement of the cart;
the base frame including a pair of spaced parallel side arms extending forwardly so as define an open area between the arms with an open front between the arms at the front of the arms;
the base frame and the arms being arranged to allow the cart to be moved forwardly so as to move the arms into a position on respective sides of a load with the load passing though the open front into the open area between the arms;
each of the arms having a respective one of the ground wheels thereon for supporting the arm;
a mast carried on the base frame;
a winch having a cable passing over a guide pulley on the mast above the open area between the arms for lifting the load in the open area;
each of the arms includes a swivel mounting for receiving and supporting a pivot coupling of a bucket to be carried between the arms, the bucket being pivotal about a horizontal transverse axis to allow dumping of the bucket when pulled by the cable.
